(19) United States
(12) Patent Application Publication
(10) Pub. No.: US 2025/0357853 A1
(43) Pub. Date: Nov. 20, 2025

(54) DC/DC CONVERTER

(71) Applicant: LX SEMICON CO., LTD., Daejeon (KR)

(72) Inventors: Young Kook AHN, Daejeon (KR); Tae Kyu NAM, Daejeon (KR); Won Suk JANG, Daejeon (KR); Chang Jin JEONG, Daejeon (KR)

(73) Assignee: LX SEMICON CO., LTD., Daejeon (KR)

(21) Appl. No.: 18/998,456

(22) PCT Filed: Jul. 18, 2023
(86) PCT No.: PCT/KR2023/010313

§ 371 Date: Jan. 24, 2025

(30) Foreign Application Priority Data
Jul. 27, 2022 (KR) 10-2022-0093096

(51) Int. Cl. H02M 3/07; H02M 3/145; H05B 45/38

(52) U.S. Cl. CPC H02M 3/07; H02M 3/145; H05B 45/38

(57) ABSTRACT

One embodiment relates to A DC/DC converter for boosting an input voltage to a desired voltage and outputting same, comprising: a boost converter for boosting an input voltage to a first voltage; a voltage drop pump for reducing the input voltage to a second voltage; and a charge pump connected to the boost converter and the voltage drop pump, wherein the charge pump generates, as an output voltage, on the basis of the first voltage that is input from the boost converter and the second voltage that is input from the voltage drop pump, a third voltage boosted to be higher than the input voltage.

### CROSS-REFERENCE TO RELATED APPLICATIONS

This application is a national phase entry of PCT International Application No. PCT/KR2023/010313, filed on Jul. 18, 2023, which claims the priority of Korean Application No. 10-2022-0093096, filed on Jul. 27, 2022, which are hereby incorporated by reference in their entirety.

### TECHNICAL FIELD

The present embodiment relates to a DC/DC converter that boosts an input voltage and outputs it.

### BACKGROUND ART

Among DC/DC converters (direct current to direct current converters) that convert the voltage of direct current power, a converter that boosts an output voltage higher than the input voltage and outputs it is called a boost converter. In some cases, a boost converter is also referred to as a step-up converter.

As an example, the size of the driving voltage of an LED string used for light emission in a display device (e.g., a liquid crystal display (LCD), an organic light emitting diode (OLED) display device, a plasma display panel (PDP) display device) can be set in various ways. In order to provide various sizes of driving voltages to the LED string, not only the boost converter but also various types of converters can be used.

In general, a boost converter controls the input voltage to be supplied to the inductor in the first time period by connecting a switching element in parallel between the inductor and the output terminal, and blocks the power supply to the output terminal. The boost converter has a structure in which the current flowing through the inductor is supplied to the output terminal while being connected to the output terminal in the second time period. The boost converter can adjust the size of the output voltage to be boosted by adjusting the duty of the switching element.

According to one embodiment, the efficiency of the boost converter can decrease as the size of the output voltage to be boosted (e.g., boost ratio) increases compared to the input voltage. In addition, if the size of the input voltage input to the boost converter is relatively large, the desired output voltage cannot be generated.

Therefore, the development of a technology that can increase the efficiency of the boost converter while obtaining the desired output voltage using the boost converter is required.

### DETAILED DESCRIPTION OF THE INVENTION

### Technical Problem

Against this backdrop, one purpose of the present embodiment is to provide a DC/DC converter capable of expanding the available range of an input voltage by receiving a reduced input voltage of a converter from a charge pump and then reducing it instead of boosting the input voltage of the converter by an integer multiple by the charge pump.

Another purpose of the present embodiment is to provide a DC/DC converter capable of reducing power consumption by reusing the reduced input voltage used to boost the input voltage of the converter by the charge pump in an integrated circuit.

### Technical Solution

In order To achieve the above-mentioned object, one embodiment may include a boost converter configured to boost an input voltage to a first voltage; a voltage drop pump configured to reduce the input voltage to a second voltage; and a charge pump connected to the boost converter and the voltage drop pump, wherein the charge pump is configured to generate a third voltage boosted from the input voltage as an output voltage based on the first voltage input from the boost converter and the second voltage input from the voltage drop pump.

Another embodiment may include a selection circuit configured to select and output a first power signal or a second power signal; a boost converter configured to boost the first power signal or the second power signal output from the selection circuit to a set first voltage; and a charge pump configured to generate a second voltage as the output voltage by boosting the first voltage output from the boost converter, wherein the charge pump is configured to bypass and output the first voltage output from the boost converter when the selection circuit selects the second power signal in response to an input control signal.

Another embodiment may include a boost converter configured to boost an input voltage to a set first voltage; a voltage drop pump configured to reduce the input voltage to a set second voltage; a charge pump configured to generate a third voltage boosted from the input voltage as an output voltage based on the first voltage and the second voltage; and a controller driven based on the second voltage generated by the voltage drop pump.

### Effects of the Invention

As described above, according to the present embodiment, instead of boosting an input voltage of a converter by an integer multiple by a charge pump, the reduced input voltage of the converter is input by the charge pump and boosted, thereby expanding an available range of the input voltage.

In addition, according to the present embodiment, the reduced input voltage used to boost the input voltage of the converter by the charge pump can be reused in an integrated circuit, thereby reducing power consumption.

### BRIEF DESCRIPTION OF THE DRAWINGS

FIG. 1 is a block diagram of a DC/DC converter according to one embodiment.

FIG. 2 is a circuit diagram of a DC/DC converter according to one embodiment.

FIG. 3 is a block diagram of a DC/DC converter according to one embodiment.

FIG. 4 is a circuit diagram of a DC/DC converter according to one embodiment.

FIG. 5A is a diagram illustrating a power path of a DC/DC converter according to one embodiment.

FIG. 5B is a diagram illustrating a power path of a DC/DC converter according to one embodiment.

FIG. 6A is a diagram illustrating a power path of a DC/DC converter according to one embodiment.

FIG. 6B is a diagram illustrating a power path of a DC/DC converter according to one embodiment.

FIG. 7 is a block diagram of a DC/DC converter according to one embodiment.

FIG. 8 is a circuit diagram of a DC/DC converter according to one embodiment.

FIG. 9 is a block diagram of a DC/DC converter according to one embodiment.

FIG. 10 is a circuit diagram of a DC/DC converter according to one embodiment.

FIG. 11 is a block diagram of a DC/DC converter according to one embodiment.

FIG. 12 is a graph illustrating mode switching of a DC/DC converter according to one embodiment.

### BEST MODE

Hereinafter, some embodiments of the present invention will be described in detail with reference to exemplary drawings. When adding reference numerals to components in each drawing, it should be noted that the same components are given the same numerals as much as possible even if they are shown in different drawings. In addition, when describing the present invention, if it is determined that a specific description of a related known configuration or function can obscure the gist of the present invention, the detailed description thereof will be omitted.

In addition, when describing components of the present invention, terms such as first, second, A, B, (a), (b), etc. can be used. These terms are only intended to distinguish the components from other components, and the nature, order, or sequence of the components are not limited by the terms. When a component is described as being “connected,” “coupled,” or “connected” to another component, it should be understood that the component can be directly connected or connected to the other component, but another component can also be “connected,” “coupled,” or “connected” between each component.

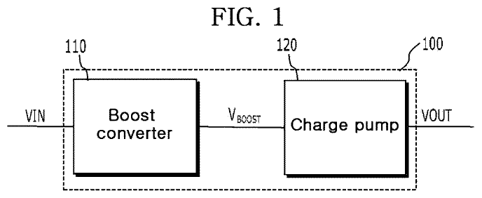

FIG. 1 is a block diagram of a DC/DC converter according to one embodiment.

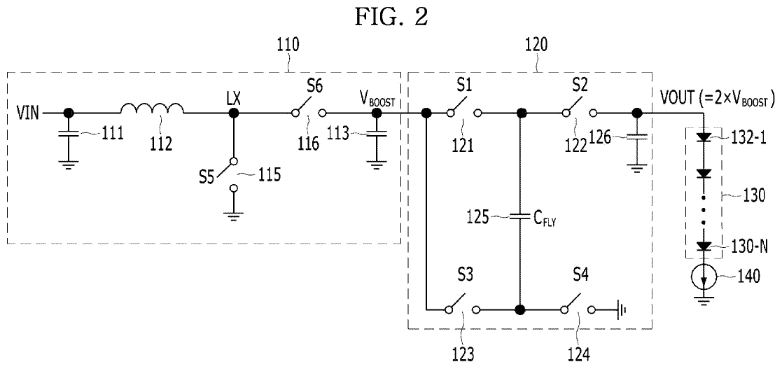

Referring to FIG. 1, a DC/DC converter 100 according to one embodiment can include a boost converter 110 and a charge pump 120. According to one embodiment, the boost converter 110 can boost an input voltage (VIN) to a first voltage higher than the input voltage (VIN). The first voltage boosted and output through the boost converter 110 will be referred to as V_{BOOST} for convenience of explanation. The charge pump 120 can boost the output voltage of the boost converter 110 to output VOUT. If VIN is boosted and VOUT is output by the DC/DC converter 100 including the boost converter 110, the efficiency of the boost converter 110 can be lowered due to a relatively high boost ratio. Therefore, as shown in FIG. 1, the efficiency of the overall DC/DC converter 100 can be increased by first boosting with a relatively low boost ratio by the boost converter 110 and then secondarily boosting through the charge pump 120. For example, in FIG. 1, the boost ratio of the boost converter 110 is relatively lower than when the boost converter 110 is used alone, so that high efficiency can be secured. In addition, the charge pump 120 can secure relatively high efficiency (e.g., 99% efficiency) by boosting by an integer multiple (e.g., 2 times) depending on the implementation. Hereinafter, with reference to FIG. 2, an example of implementing the DC/DC converter 100 of FIG. 1 will be described. The circuit diagram of FIG. 2 is merely exemplary, and the embodiments are not limited thereto.

FIG. 2 is a circuit diagram of a DC/DC converter according to one embodiment.

Referring to FIG. 2, a DC/DC converter 100 according to one embodiment can include a boost converter 110 and a charge pump 120. According to one embodiment, the boost converter 110 can include an input capacitor 111, an inductor 112, a fifth switch (S5) 115, a sixth switch (S6) 116, and a first output capacitor 113. According to one embodiment, an input voltage (VIN) can pass through the inductor 112, the LX node, and be output through the sixth switch 116. As described above, the boost converter 110 can boost the input voltage (VIN) to a first voltage (V_{BOOST}) higher than the input voltage (VIN). In the boost converter 110, the input capacitor 111 is connected in parallel at the front end of the inductor 112, and the fifth switch 115 can be connected in parallel at the LX node, which is the rear end of the inductor 112. The first output capacitor 113 can be connected in parallel at the rear end of the sixth switch 116.

Hereinafter, the operation of the boost converter 110 will be described. According to one embodiment, when the fifth switch 115 is turned on and the sixth switch 116 is turned off, the input voltage (VIN) flows to the inductor 112, and current can be built up in the inductor 112. The current flowing through the inductor 112 flows through the fifth switch 115 that is turned on at the LX node, and since the sixth switch 116 is turned off, no current flows to the output terminal. Next, when the fifth switch 115 is turned off and the sixth switch 116 is turned on, the current built up in the inductor 112 can be transferred to the first output capacitor 113 through the sixth switch 116. In this way, the boost converter 110 can boost the input voltage (VIN) to a first voltage (V_{BOOST}) that is higher than the input voltage (VIN) by repeatedly turning the fifth switch 115 on and off and the sixth switch 116 on and off every cycle (T). The size of the first voltage (V_{BOOST}) boosted by the boost converter 110 can be determined by the duty of the switching elements (e.g., the fifth switch 115 and the sixth switch 116) included in the boost converter 110. The switching elements (e.g., the fifth switch 115 and the sixth switch 116) included in the boost converter 110 can be implemented with various switchable elements. For example, the switching elements can include various transistors such as a field-effect transistor (FET) as well as a bipolar junction transistor (BJT), but are not limited thereto.

According to one embodiment, the charge pump 120 can include a plurality of switches (e.g., a first switch (S1) 121, a second switch (S2) 122, a third switch (S3) 123, a fourth switch (S4) 124), a flying capacitor (C_{FLY}) 125, and a second output capacitor 126. An input voltage of the charge pump 120 can correspond to an output voltage of the boost converter 110. An input terminal of the charge pump 120 can have a first switch 121 and a third switch 123 connected in parallel. The first switch 121 can be connected in series with the second switch 122 and connected to an output terminal. The second output capacitor 126 can be connected in parallel to an output terminal of the charge pump 120. The third switch 123 is connected in series with the fourth switch 124 and can be connected to ground. The node between the first switch 121 and the second switch 122 and the node between the third switch 123 and the fourth switch 124 can be connected to each other by a flying capacitor 125.

As described above, the charge pump 120 can boost and output an input voltage (e.g., a first voltage (V_{BOOST}) boosted by the boost converter 110. For example, the charge pump 120 can output a voltage boosted by an integer multiple (e.g., 2 times) of the input voltage by turning on or off the plurality of switches (e.g., the first switch (S1) 121, the second switch (S2) 122, the third switch (S3) 123, and the fourth switch (S4) 124). In FIG. 2, when it is assumed that the output voltage of the charge pump 120 is a voltage boosted by 2 times the input voltage, the output voltage (VOUT) can be twice (2×V_{BOOST}) of the first voltage (V_{BOOST}). The second boosted output voltage (VOUT) from the charge pump 120 can be supplied as a driving voltage for various loads. For example, as shown in FIG. 2, the output voltage (VOUT) of the charge pump 120 can be applied to an LED string 130 in which a plurality of light emitting diodes (LEDs) (130-1, . . . , 130-N) are connected in series. The current flowing through the LED string 130 can flow to the ground through the current source (140).

Hereinafter, the operation of the charge pump 120 will be described. According to one embodiment, in the first time period, the first switch 121 and the fourth switch 124 can be turned on, and the second switch 122 and the third switch 123 can be turned off. Accordingly, the current flowing into the input terminal flows to the ground through the first switch 121, the flying capacitor 125, and the fourth switch 124 by the input voltage (V_{BOOST}) applied to the input terminal of the charge pump 120. For convenience of explanation, this will be referred to as the first power path. In the first time period, the flying capacitor 125 can be charged along the first power path. According to one embodiment, in the second time period, the first switch 121 and the fourth switch 124 can be turned off, and the second switch 122 and the third switch 123 can be turned on. Accordingly, the current flowing to the input terminal by the input voltage (V_{BOOST}) applied to the input terminal of the charge pump 120 flows to the second output capacitor 126 through the third switch 123, the flying capacitor 125, and the second switch 122. For convenience of explanation, this will be referred to as the second power path. In the second time period, the flying capacitor 125 can be discharged to the output terminal according to the second power path. In this way, the charge pump 120 can boost the input voltage (V_{BOOST}) of the charge pump 120 to an output voltage (VOUT) (2×V_{BOOST}) that is twice higher than the input voltage (V_{BOOST}) by repeating the turning on and off of the first switch 121 and the fourth switch 124 for each cycle (T), and repeating the turning off and on of the second switch 122 and the third switch 123. The switching elements included in the charge pump 120 (e.g., the first switch (S1) 121, the second switch (S2) 122, the third switch (S3) 123, and the fourth switch (S4) 124) can be implemented with various switchable elements. For example, the switching element can include various transistors such as a field-effect transistor (FET) as well as a bipolar junction transistor (BJT), but is not limited thereto.

According to one embodiment, as shown in FIGS. 1 and 2, in order to increase the efficiency of the DC/DC converter 100, the input voltage can be boosted to a desired output voltage by connecting a boost converter 110 and a charge pump 120 in series.

As described above, in the DC/DC converter 100 illustrated in FIGS. 1 and 2, the charge pump 120 boosts the output voltage of the boost converter 110 by two times, so that in order to obtain the desired final output voltage (VOUT) of the DC/DC converter 100, the output voltage (V_{BOOST}) of the boost converter 110 can be half (e.g., VOUT/2) of the output voltage (VOUT) of the charge pump 120. In addition, since the input voltage of the boost converter 110 is boosted according to the duty of the switching element as described above, the input voltage of the boost converter 110 can be a voltage lower than the output voltage of the boost converter 110 (e.g., VOUT/2).

For example, if the voltage to be supplied to the LED string 130 is 28V, the output voltage of the charge pump 120 is 28V, so the input voltage of the charge pump 120 can be set to 14V. If the input voltage (VIN) input to the DC/DC converter 100 is 12V input from a battery, the input voltage of 12V is first boosted to 14V by the boost converter 110, and then the voltage boosted to 14V is secondarily boosted to 28V by the charge pump 120, thereby supplying a voltage of 28V suitable for the LED string 130. On the other hand, if an adapter is connected to the DC/DC converter 100 and the input voltage (VIN) input to the DC/DC converter 100 is 19V from the adapter, when the boost converter 110 boosts the input voltage of 19V for the first time, the charge pump 120 must boost the voltage boosted for the first time to a voltage twice higher, so it cannot be possible to generate a 28V voltage suitable for the LED string 130.

As a specific example, referring to Table 1 below, if the desired output voltage ((VOUT) is set to 30V, assuming that the minimum duty of V_{BOOST} is 1%, the maximum value of the inputtable VIN can be 14. 85V.

TABLE 1

| | | |
|---|---|---|
| VIN.max | V_{BOOST} | VOUT |

| | | | |
|---|---|---|---|
| 6 | V | 15 V | 30 V |
| 14.85 | V | 15 V | 30 V |

According to one embodiment, referring to Table 1 above, when VOUT is set to 30V, the DC/DC converter 100 cannot be able to generate a normal output voltage with an input voltage of 14.85V or higher. For example, an adapter having an output voltage of 19V cannot be converted to a desired output voltage through the DC/DC converter 100. In addition, assuming that the input voltage (VIN) of the DC/DC converter 100 is 12V and the minimum duty of V_{BOOST} is 1%, the minimum value of the output voltage (VOUT) of the DC/DC converter 100 can be 24.24V as shown in Table 2 below.

TABLE 2

| VIN | V_{BOOST} | VOUT.min |
|---|---|---|
| 12 V | 12.12 V | 24.24 V |

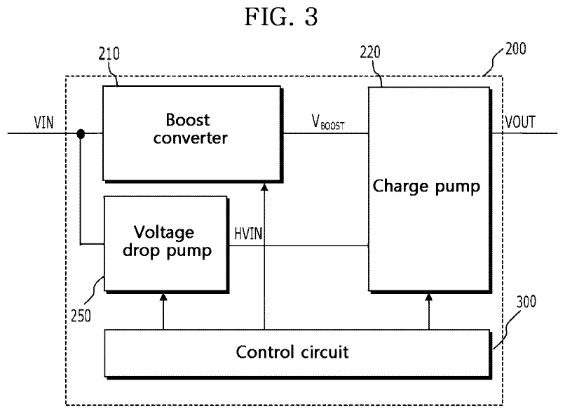

Referring to Table 2 above, when an input voltage of 12 V is supplied by the DC/DC converter 100 of the aforementioned FIGS. 1 and 2, an output voltage of less than 24.24V cannot be generated. Hereinafter, referring to FIGS. 3 to 12, various embodiments that can increase the efficiency of the DC/DC converter 100 by connecting the boost converter 110 and the charge pump 120 in series as described above while generating a desired output voltage even when the input voltage is a relatively high voltage (e.g., 19V voltage input from an adapter) will be described.

FIG. 3 is a block diagram of a DC/DC converter according to one embodiment.

Referring to FIG. 3, a DC/DC converter 200 according to one embodiment can include a boost converter 210, a charge pump 220, and a voltage drop pump 250. The DC/DC converter 200 can further include a control circuit 300. The voltage drop pump 250 can be connected in parallel with the boost converter 210 to receive the input voltage (VIN) of the DC/DC converter 200 as a common input voltage.

According to one embodiment, the boost converter 210 can boost the input voltage (VIN) to a first voltage higher than the input voltage (VIN). The first voltage boosted and output through the boost converter 110 will be referred to as V_{BOOST} for convenience of explanation. According to one embodiment, the voltage drop pump 250 can reduce the input voltage (VIN) to a second voltage lower than the input voltage (VIN). The second voltage reduced and output through the voltage drop pump 250 will be referred to as HVIN for convenience of explanation.

According to one embodiment, as illustrated in FIG. 3, a first input terminal of the charge pump 220 can be connected to an output terminal of the boost converter 220, and a second input terminal of the charge pump 220 can be connected to an output terminal of the voltage drop pump 250. For example, in FIGS. 1 and 2, only the output terminal of the boost converter 110 is connected to the input terminal of the charge pump 120, but as illustrated in FIG. 3, in the charge pump 220 according to one embodiment, the output terminal of the boost converter 210 and the output terminal of the voltage drop pump 250 can be connected together. For example, the charge pump 220 can receive the output voltage (V_{BOOST}) of the boost converter 210 and the output voltage (HVIN) of the voltage drop pump 250 as input voltages simultaneously and generate a third voltage that is boosted higher than the input voltage (VIN) of the DC/DC converter 200 as an output voltage. For example, the third voltage, which is the output voltage (VOUT) of the charge pump 220, can be generated as a sum of the first voltage, which is the output voltage (V_{BOOST}) of the boost converter 210, and the second voltage, which is the output voltage (HVIN) of the voltage drop pump 250, as in the following <Mathematical Formula 1>.

$$VOUT = {V}_{B O O S T} + HVIN \qquad [ Mathematical Formula 1 ]$$

According to various embodiments, the voltage drop pump 250 can reduce the input voltage (VIN) of the DC/DC converter 200 by at least one ratio of ½, ⅓, or ¼. For example, the output voltage HVIN of the voltage drop pump 250 can be set to VIN/2, VIN/3, VIN/4, etc., and various embodiments are not limited to the above-mentioned set values. According to another embodiment, the voltage drop pump 250 can also output the input voltage (VIN) by bypassing it. At this time, the output voltage HVIN of the voltage drop pump 250 can be VIN. According to one embodiment, the voltage drop pump 250 can be implemented in various forms. For example, the voltage drop pump 250 can include a plurality of series-connected capacitors and a plurality of switching elements that control the connection between the plurality of capacitors. The voltage drop pump 250 can connect the series-connected capacitors in parallel by controlling the plurality of switching elements. An output voltage (e.g., VIN/2, VIN/3, VIN/4, etc.) that is reduced by an integer multiple can be obtained through the parallel-connected capacitors.

According to one embodiment, the control circuit 300 can transmit a first control signal to the voltage drop pump 250 and adjust a reduction ratio of the voltage drop pump 250 based on the first control signal. For example, when the first control signal transmitted from the control circuit 300 to the voltage drop pump 250 corresponds to a first set value, the voltage drop pump 250 can generate an output voltage of VIN/2. When the first control signal transmitted from the control circuit 300 to the voltage drop pump 250 corresponds to the second set value, the voltage drop pump 250 can generate an output voltage of VIN/3. When the first control signal transmitted from the control circuit 300 to the voltage drop pump 250 corresponds to the third set value, the voltage drop pump 250 can generate an output voltage of VIN/2. When the first control signal transmitted from the control circuit 300 to the voltage drop pump 250 corresponds to the fourth set value, the voltage drop pump 250 can be controlled to bypass the input voltage (VIN) and generate an output voltage of VIN.

According to one embodiment, the control circuit 300 can transmit a second control signal to the boost converter 210 and adjust the first voltage boosted by the boost converter 210 based on the second control signal. For example, the magnitude of the first voltage boosted by the boost converter 210 based on the second control signal can be determined by the duty of the switching element included in the boost converter 210.

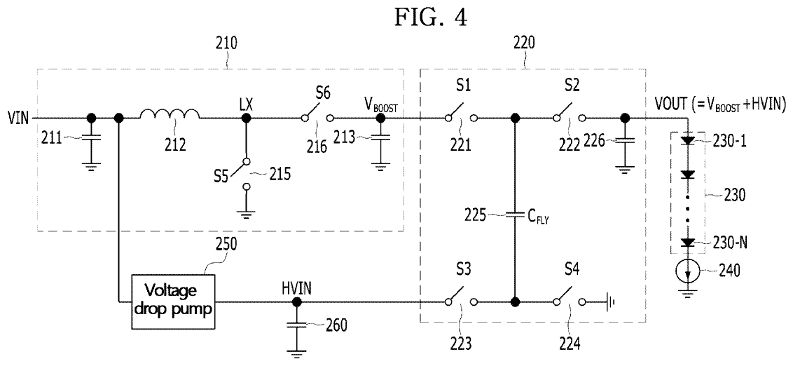

According to one embodiment, the control circuit 300 can transmit a third control signal to the charge pump 220 and generate the third voltage based on the third control signal. A specific example thereof will be described later in the description of FIG. 4.

According to one embodiment, according to the DC/DC converter 200 of FIG. 3, even if input voltages of various magnitudes are supplied, a desired output voltage can be obtained. For example, compared to the aforementioned Table 1 and Table 2, the DC/DC converter 200 of the above-described FIG. 3 can generate a desired output voltage by boosting a variety of input voltages as shown in Table 3 below.

TABLE 3

| | | | | | | | Mode of Voltage drop |
|---|---|---|---|---|---|---|---|
| VIN.max | | HVIN | | V_{BOOST} | | VOUT | pump |
| 6 | V | 6 | V | 24 | V | 30 V | Bypass mode (×1) |
| 12 | V | 12 | V | 18 | V | 30 V | Bypass mode (×1) |
| 15 | V | 7.5 | V | 22.5 | V | 30 V | ½ mode (×0.5) |
| 21 | V | 5.25 | V | 24.75 | V | 30 V | ¼ mode (×0.25) |
| 23 | V | 5.75 | V | 24.75 | V | 30 V | ¼ mode (×0.25) |

Referring to Table 3 above, assuming that the desired output voltage (VOUT) of the DC/DC converter 200 is 30V, the desired output voltage (VOUT) of 30V can be generated even when VIN is 6V, 12V, 15V, 21V, or 23V. For example, when VIN is 6V, the voltage drop pump 250 is set to bypass mode to output 6V, which is the same as the input voltage (VIN), and the duty of the boost converter 210 is adjusted to output a voltage that is boosted four times to 24V, thereby generating the output voltage of the charge pump 220 as 30 V (6V+24V). When VIN is 12V, the voltage drop pump 250 is set to bypass mode to output 6 V, which is the same as the input voltage (VIN), and the duty of the boost converter 210 is adjusted to output a voltage boosted to 18V, thereby generating the output voltage of the charge pump 220 at 30V (12V+18V). When VIN is 15V, the voltage drop pump 250 is set to ½ mode to output 7.5V, which is ½ times lowered from the input voltage (VIN), and the duty of the boost converter 210 is adjusted to output a voltage boosted to 22.5V, thereby generating the output voltage of the charge pump 220 at 30V (7.5V+22.5V). When VIN is 21V, the voltage drop pump 250 is set to ¼ mode to output 5.25V, which is 1/4 times lower than the input voltage (VIN), and the duty of the boost converter 210 is adjusted to output a voltage boosted to 24.75V, thereby generating the output voltage of the charge pump 220 at 30V (5.25V+24. 75V). When VIN is 23V, the voltage drop pump 250 is set to ¼ mode to output 5.75V, which is 1/4 times lowered from the input voltage (VIN), and the duty of the boost converter 210 is adjusted to output a voltage boosted to 24. 25V, thereby generating the output voltage of the charge pump 220 as 30V (5.75V+24.25V). According to one embodiment, according to the DC/DC converter 200 of FIG. 3, when an input voltage of 12V is supplied, various output voltages can be obtained as shown in Table 4 below by adjusting the mode of the voltage drop pump 250.

TABLE 4

| | | | | Mode of Voltage drop |
|---|---|---|---|---|
| VIN | HVIN | V_{BOOST} | VOUT.min | pump |
| 12 V | 6 V | 12.12 V | 18.12 V | ½ mode (×0.5) |
| 12 V | 3 V | 12.12 V | 15.12 V | ¼ mode (×0.25) |

Referring to the above Table 4, when an input voltage of 12V is supplied by the DC/DC converter 200 of the aforementioned FIG. 3, an output voltage of less than 24. 24V, such as 18. 12V or 15. 12V, can also be generated by adjusting the mode of the voltage drop pump 250. Hereinafter, with reference to FIG. 4, an example of implementing the DC/DC converter 200 of the aforementioned FIG. 3 will be described. The circuit diagram of FIG. 4 is only exemplary and is not limited thereto.

FIG. 4 is a circuit diagram of a DC/DC converter according to one embodiment.

Referring to FIG. 4, the DC/DC converter 200 according to one embodiment can include a boost converter 210, a charge pump 220, and a voltage drop pump 250. According to one embodiment, the boost converter 210 can include an input capacitor 211, an inductor 212, a fifth switch (S5) 215, a sixth switch (S6) 216, and a first output capacitor 213. According to one embodiment, the input voltage (VIN) can pass through the inductor 212, the LX node, and be output through the sixth switch 216. As described above, the boost converter 210 can boost the input voltage (VIN) to a first voltage (V_{BOOST}) higher than the input voltage (VIN). In the boost converter 210, the input capacitor 211 can be connected in parallel at a front end of the inductor 212, and the fifth switch 215 can be connected in parallel at a rear end LX node of the inductor 212. The first output capacitor 213 can be connected in parallel at the rear end of the sixth switch 216.

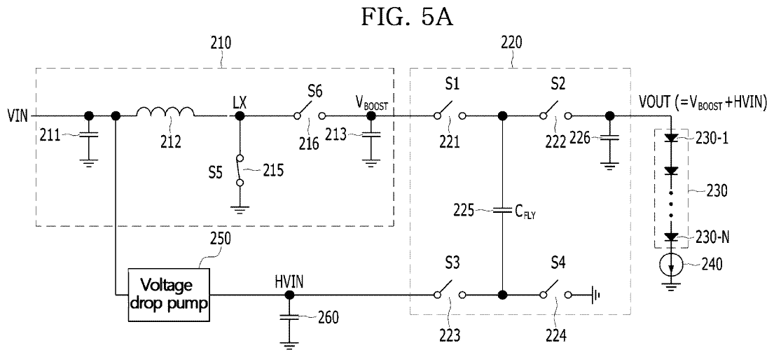

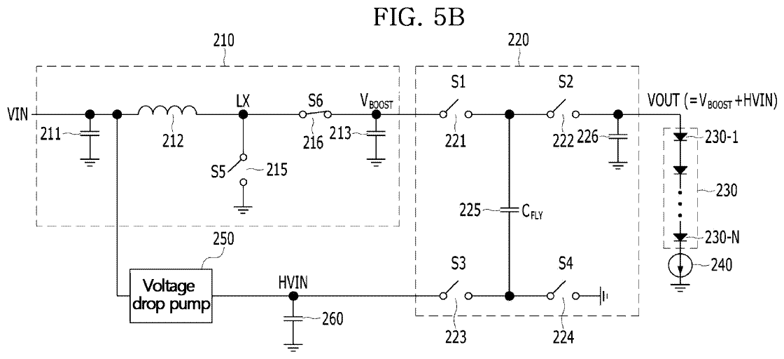

Hereinafter, the operation of the boost converter 210 will be described with reference to FIGS. 5A and 5B. FIG. 5A is a diagram illustrating a power path of a DC/DC converter according to one embodiment. FIG. 5B is a diagram illustrating a power path of a DC/DC converter according to one embodiment.

Referring to FIG. 5A, according to one embodiment, the fifth switch 215 can be turned on and the sixth switch 216 can be turned off. At this time, the input voltage (VIN) can flow to the inductor 212, and current can be built up in the inductor 212. The current flowing through the inductor 212 flows through the fifth switch 215 that is turned on at the LX node, and since the sixth switch 216 is turned off, it does not flow to the output terminal.

Referring to FIG. 5B, according to one embodiment, the fifth switch 215 can be turned off and the sixth switch 216 can be turned on. At this time, the current built up in the inductor 212 can be transferred to the first output capacitor 213 through the sixth switch 216. In this way, the boost converter 210 can boost the input voltage (VIN) to a first voltage (V_{BOOST}) that is higher than the input voltage (VIN) by repeating the turning on and off of the fifth switch 215 and the turning off and on of the sixth switch 216 for each cycle (T). The size of the first voltage (V_{BOOST}) boosted by the boost converter 210 can be determined by the duty of the switching elements (e.g., the fifth switch 215 and the sixth switch 216) included in the boost converter 210. The switching elements (e.g., the fifth switch 215 and the sixth switch 216) included in the boost converter 210 can be implemented with various switchable elements. For example, the switching elements can include various transistors such as a field-effect transistor (FET) as well as a bipolar junction transistor (BJT), but are not limited thereto.

According to one embodiment, the voltage drop pump 250 can reduce the input voltage (VIN) of the DC/DC converter 200 by at least one of ½, ⅓, or ¼. For example, the output voltage HVIN of the voltage drop pump 250 can be set to VIN/2, VIN/3, VIN/4, etc., and various embodiments are not limited to the above-mentioned set values. According to another embodiment, the voltage drop pump 250 can output by bypassing the input voltage (VIN). At this time, the output voltage HVIN of the voltage drop pump 250 can be VIN. A third output capacitor 260 can be connected in parallel to the output terminal of the voltage drop pump 250.

According to one embodiment, the voltage drop pump 250 can be implemented in various forms. For example, the voltage drop pump 250 can include a plurality of series-connected capacitors and a plurality of switching elements that control the connection between the plurality of capacitors. The voltage drop pump 250 can connect the series-connected capacitors in parallel by controlling the plurality of switching elements. Through the above parallel-connected capacitors, an output voltage (e.g., VIN/2, VIN/3, VIN/4, etc.) that is reduced by an integer multiple can be obtained.

According to one embodiment, the charge pump 220 can include a plurality of switches (e.g., a first switch (S1) 221, a second switch (S2) 222, a third switch (S3) 223, a fourth switch (S4) 224), a flying capacitor (CFLY) 225, and a second output capacitor 226. For convenience of explanation, among the input terminals of the charge pump 220, the input terminal connected to the first switch 221 will be referred to as the first input terminal, and the input terminal connected to the third switch 223 will be referred to as the second input terminal. According to one embodiment, the first input terminal of the charge pump 220 can be connected to the output terminal of the boost converter 210, and the second input terminal of the charge pump 220 can be connected to the output terminal of the voltage drop pump 250. For example, V_{BOOST}, which is an output voltage of the boost converter 210, can be applied to the first input terminal of the charge pump 220, and HVIN, which is an output voltage of the voltage drop pump 250, can be applied to the second input terminal of the charge pump 220. As described above, the charge pump 220 can receive V_{BOOST}, which is an output voltage of the boost converter 210, and HVIN, which is an output voltage of the voltage drop pump 250 through the first input terminal and the second input terminal, and generate an output voltage (VOUT). For example, the output voltage of the charge pump 220 can be generated as a sum of the first voltage, which is the output voltage (V_{BOOST}) of the boost converter 210, and the second voltage, which is the output voltage (HVIN) of the voltage drop pump 250, as in the above-described <Mathematical Formula 1>.

As shown in FIG. 4, the first switch 221 connected to the first input terminal can be connected in series with the second switch 222 and connected to the output terminal. The second output capacitor 226 can be connected in parallel to the output terminal of the charge pump 220. The third switch 223 connected to the second input terminal can be connected in series with the fourth switch 224 and connected to ground. The node between the first switch 221 and the second switch 222 and the node between the third switch 223 and the fourth switch 224 can be connected to each other by a flying capacitor 225.

As described above, the charge pump 220 can generate an output voltage that is the sum of two input voltages (e.g., a first voltage (V_{BOOST}) boosted by the boost converter 110 and a second voltage (HVIN) stepped down by the voltage drop pump 250. For example, the charge pump 220 can output a boosted voltage equal to the sum of the input voltages by turning on or off the plurality of switches (e.g., a first switch (S1) 221, a second switch (S2) 222, a third switch (S3) 223, and a fourth switch (S4) 224). The output voltage (VOUT) boosted by the charge pump 220 can be supplied as a driving voltage of various loads. For example, as illustrated in FIG. 4, the output voltage (VOUT) of the charge pump 220 can be applied to an LED string 230 in which a plurality of light emitting diodes (LEDs) (230-1, . . . , 230-N) are connected in series. The current flowing through the LED string 130 can flow to the ground through a current source 240. According to one embodiment, the voltage to be applied to the LED string 230 can be set based on the number of the plurality of LEDS. For example, assuming that the LED string 130 includes 10 LEDs and the forward voltage of each LED is 3V, the voltage applied to light the LED string 230 can be 30 V (10×3V). Accordingly, the output voltage of the DC/DC converter 200 can be set to 30 V.

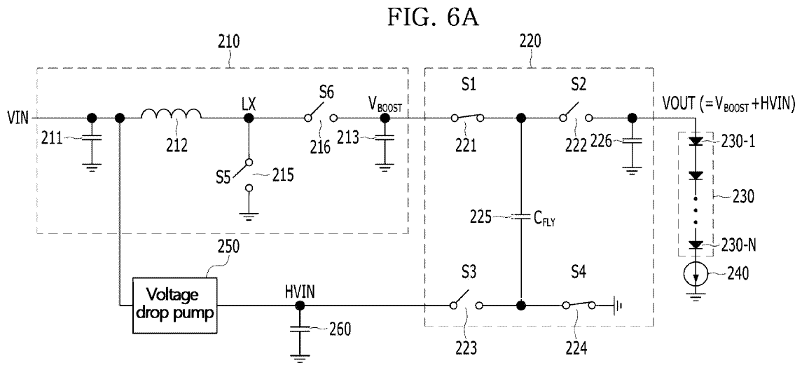

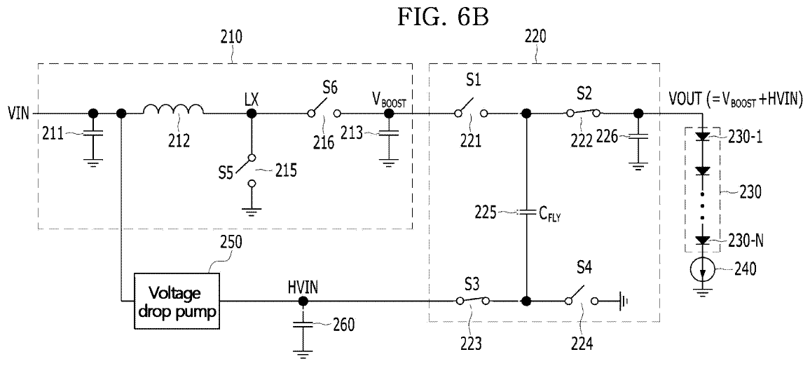

Hereinafter, the operation of the charge pump 220 will be described with reference to FIGS. 6A and 6B. FIG. 6A is a diagram illustrating a power path of a DC/DC converter according to one embodiment. FIG. 6B is a diagram illustrating a power path of a DC/DC converter according to one embodiment.

Referring to FIG. 6A, according to one embodiment, in a first time period, the first switch 221 and the fourth switch 224 can be turned on, and the second switch 222 and the third switch 223 can be turned off. Accordingly, the current flowing to the input terminal of the charge pump 220 flows to the ground through the first switch 221, the flying capacitor 225, and the fourth switch 224 by the input voltage (V_{BOOST}) applied to the first input terminal. For convenience of explanation, this will be referred to as the first power path. In the first time period, the flying capacitor 225 can be charged along the first power path.

Referring to FIG. 6B, according to one embodiment, in the second time period, the first switch 221 and the fourth switch 224 can be turned off, and the second switch 222 and the third switch 223 can be turned on. Accordingly, the current flowing to the input terminal by the input voltage (HVIN) applied to the second input terminal of the charge pump 220 flows to the second output capacitor 226 through the third switch 223, the flying capacitor 225, and the second switch 222. For convenience of explanation, this will be referred to as the second power path. In the second time period, the flying capacitor 225 can be discharged to the output terminal along the second power path. In this way, the charge pump 220 can receive two input voltages (V_{BOOST} and HVIN) of the charge pump 120 and generate a summed output voltage (VOUT) (V_{BOOST}+HVIN) while the first switch 221 and the fourth switch 224 repeat turning on and off for each cycle (T), and the second switch 222 and the third switch 223 repeat turning off and on. The switching elements included in the charge pump 220 (e.g., the first switch (S1) 221, the second switch (S2) 222, the third switch (S3) 223, and the fourth switch (S4) 224) can be implemented with various switchable elements. For example, the switching element can include various transistors such as a field-effect transistor (FET) as well as a bipolar junction transistor (BJT), but is not limited thereto.

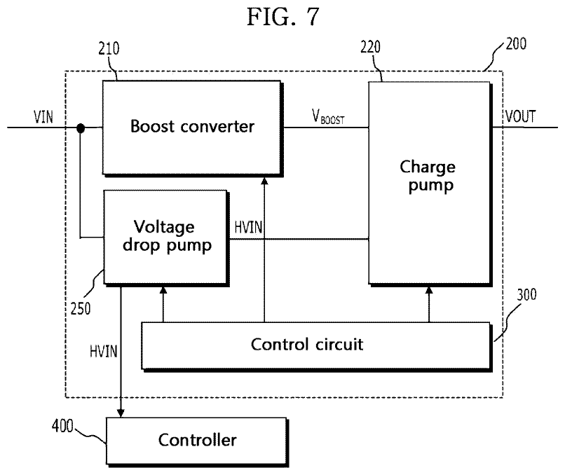

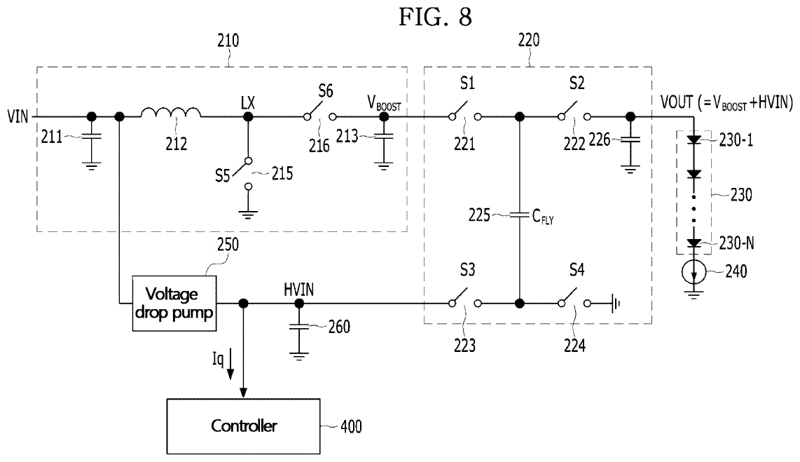

FIG. 7 is a block diagram of a DC/DC converter according to one embodiment. FIG. 8 is a circuit diagram of a DC/DC converter according to one embodiment.

Referring to FIGS. 7 and 8, according to one embodiment, the second voltage reduced by the voltage drop pump 250 as described above can be supplied as driving power to a controller 400 implemented as an integrated circuit (IC). For example, the input voltage (VIN) can be converted into a voltage usable by the controller 400 through an LDO (low dropout) regulator and then supplied to the controller 400. According to one embodiment, by supplying the voltage-dropped current (Iq) from the voltage drop pump 250 to the controller 400, as illustrated in FIG. 7, unnecessary current consumption for generating a usable voltage in the controller 400 can be reduced.

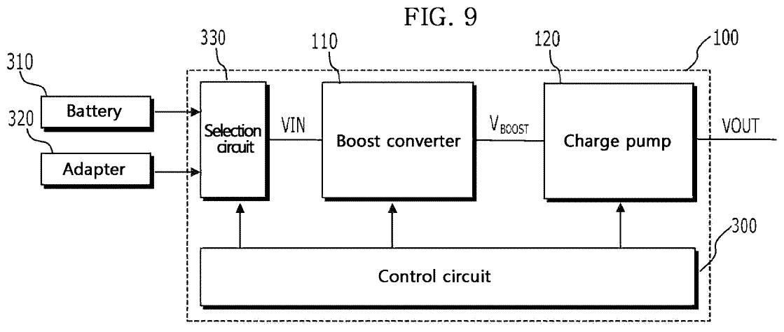

FIG. 9 is a block diagram of a DC/DC converter according to one embodiment.

Referring to FIG. 9, a DC/DC converter 100 according to one embodiment can include a boost converter 110, a charge pump 120, a control circuit 300, and a selection circuit 330. The operations of the boost converter 110 and the charge pump 120 can be the same as or similar to the operations described above in FIGS. 1 and 2, so a detailed description thereof will be omitted.

According to one embodiment, the DC/DC converter 100 can receive an input voltage from a battery 310 or an adapter 320. The input voltage supplied from the adapter 320 and the input voltage supplied from the battery 310 can be different from each other. For example, the magnitude of the input voltage supplied from the adapter 320 can be greater than the magnitude of the input voltage supplied from the battery 310. As an example, the input voltage supplied from the adapter 320 can be 19V, and the input voltage supplied from the battery 310 can be 12V. As described above in the description of FIGS. 1 and 2, since the output voltage of the boost converter 110 is doubled in the charge pump 120, a desired output voltage (e.g., 30V) can be generated from the input voltage supplied from the battery 310, but a desired output voltage (e.g., 30V) cannot be generated from the input voltage supplied from the adapter 320.

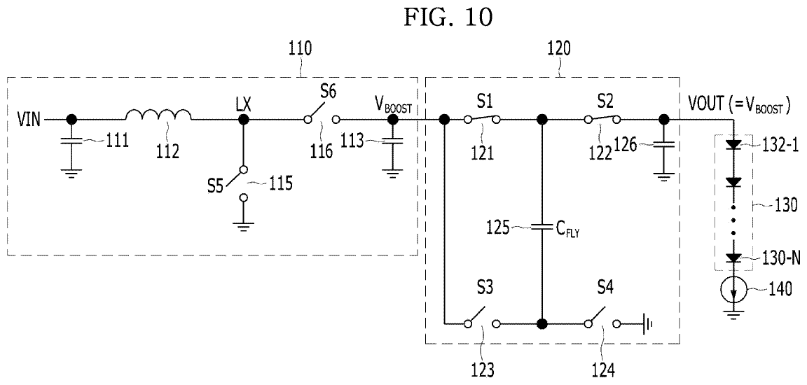

According to one embodiment, the control circuit 300 can control the selection circuit 330. For example, when the adapter 320 is not connected to the electronic device (e.g., a laptop), the control circuit 300 can control the selection circuit 330 to allow the output voltage (e.g., 12V) of the battery 310 to be supplied to the DC/DC converter 100. On the other hand, when the adapter 320 is connected to the electronic device (e.g., a laptop), the control circuit 300 can control the selection circuit 330 to allow the output voltage (e.g., 19V) of the adapter 320 to be supplied to the DC/DC converter 100. According to one embodiment, when the selection circuit 330 selects the adapter 320 to be connected to the DC/DC converter 100, the control circuit 300 can control the charge pump 120 to operate in a bypass mode, as illustrated in FIG. 10.

FIG. 10 is a circuit diagram of a DC/DC converter according to one embodiment.

Referring to FIG. 10, when the selection circuit 330 selects the adapter 320 to be connected to the DC/DC converter 100 as described above, the charge pump 120 can be controlled to operate in a bypass mode to generate a desired output power.

For example, when 19V, which is the output voltage of the adapter 320, is input to the boost converter 110 of the DC/DC converter 100, the boost converter 110 can receive 19V, which is the output voltage of the adapter 320, boost it to 30V, and output it. Therefore, the output voltage (V_{BOOST}) of the boost converter 110 can be 30V. At this time, the charge pump 120 can be controlled to operate in a bypass mode by the control circuit 300. As the charge pump 120 operates in the bypass mode, the charge pump 120 can generate and output a voltage (VOUT) that is the same as the output voltage (V_{BOOST}) of the boost converter 110, which is 30 V.

According to one embodiment, as shown in FIG. 10, as the charge pump 120 operates in the bypass mode, the first switch 121 and the second switch 122 can be controlled to be turned on, and the third switch 123 and the fourth switch 124 can be controlled to be turned off. The output voltage (V_{BOOST}) of the boost converter 110 can be output to the second output capacitor 126 through the first switch 121 and the second switch 122 that are turned on.

According to the above-described embodiment, even if the DC/DC converter 100 is configured by connecting the boost converter 110 and the charge pump 120 in series, it can receive a relatively high input voltage and generate a boosted output voltage.

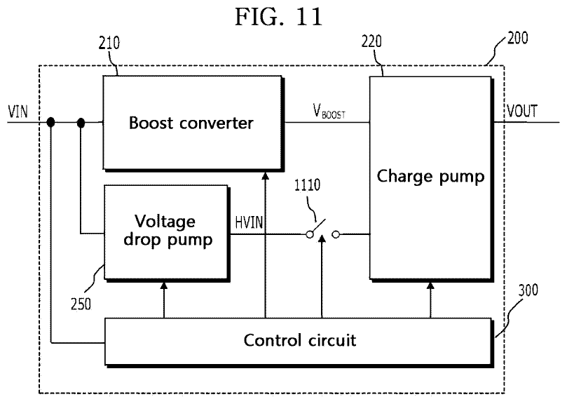

FIG. 11 is a block diagram of a DC/DC converter according to one embodiment.

Referring to FIG. 11, the DC/DC converter 200 can include a boost converter 210, a charge pump 220, a voltage drop pump 250, a control circuit 300, and a switch 1110.

According to one embodiment, the control circuit 300 can selectively supply the output voltage of the voltage drop pump 250 to the charge pump 220 by controlling the switch 1110. For example, the control circuit 300 can set the output voltage (VOUT) of the charge pump 220 to be the sum of the output voltage (V_{BOOST}) of the boost converter 210 and the output voltage (HVIN) of the voltage drop pump 250 as described above in FIGS. 3 and 4 by controlling the switch 1110 to be turned on when the input voltage (VIN) of the DC/DC converter 200 corresponds to the first voltage range. As another example, the control circuit 300 can set the output voltage (VOUT) of the charge pump 220 to be twice (2×V_{BOOST}) the output voltage (V_{BOOST}) of the boost converter 210 as described above in FIGS. 1 and 2 by controlling the switch 1110 to be turned off when the input voltage (VIN) of the DC/DC converter 200 corresponds to the second voltage range different from the first voltage range.

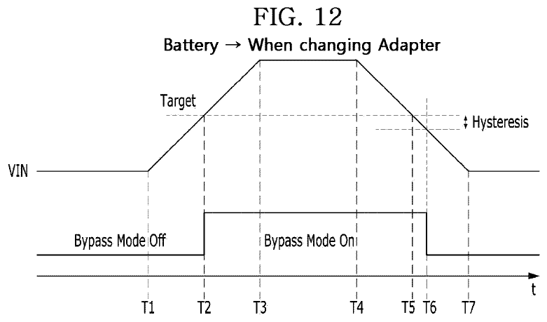

FIG. 12 is a graph illustrating the mode switching of the DC/DC converter according to one embodiment.

Referring to FIG. 12, an adapter can be connected at a time point T1 while the electronic device is being powered from a battery. At this time, the input voltage (VIN) of the DC/DC converter 100 can gradually increase at a time point T1. The charge pump 120 of the DC/DC converter 100 can be controlled so that the bypass mode is turned off. When the input voltage gradually increases over time and reaches the target voltage at a time point T2, the mode of the charge pump 120 can be controlled to the bypass mode. The target voltage can be a minimum voltage level (e.g., 14.85V as described in <Table 1>) that cannot be processed by the aforementioned DC/DC converter 100. Afterwards, as the voltage of 19V is stably supplied from the adapter from the time point T3 to the time point T4, the charge pump 120 can be controlled to continuously maintain the bypass mode. As the adapter is disconnected at the time point T4 and power is supplied from the battery, the input voltage can gradually decrease from 19V. As time passes, the voltage can be lower than the target voltage described above at the time point T5, and the bypass mode of the charge pump 120 can be controlled to be switched off at the time point T6 by applying hysteresis. As time passes, the input voltage of the battery, 12V, can be maintained at the time point T7, and the output voltage can be generated by the first boosting by the boost converter 110 and the second boosting by the charge pump 120 as described above in FIGS. 1 and 2.

As described above, according to the present embodiment, instead of boosting the input voltage of the DC/DC converter 100 by an integer multiple by the charge pump 120, the input voltage of the converter, which has been reduced by the voltage drop pump 250, is received by the charge pump 220 and boosted, thereby expanding the available range of the input voltage.

In addition, according to the present embodiment, the reduced input voltage (e.g., the output voltage of the voltage drop pump 250) used to boost the input voltage of the DC/DC converter 200 by the charge pump 220 can be reused in an integrated circuit such as the controller 400, thereby reducing power consumption.

1. A DC/DC converter comprising:
a boost converter configured to boost an input voltage to a first voltage;
a voltage drop pump configured to reduce the input voltage to a second voltage; and
a charge pump connected to the boost converter and the voltage drop pump,
wherein the charge pump is configured to generate a third voltage boosted from the input voltage as an output voltage based on the first voltage input from the boost converter and the second voltage input from the voltage drop pump.

2. The DC/DC converter of claim 1, wherein the charge pump includes:
a first input terminal connected to an output terminal of the boost converter and configured to receive the first voltage, and
a second input terminal connected to an output terminal of the voltage drop pump and configured to receive the second voltage.

3. The DC/DC converter of claim 1, wherein the output voltage of the charge pump has a voltage value that is the sum of the first voltage and the second voltage, and includes the third voltage having a higher voltage value than the input voltage.

4. The DC/DC converter of claim 1, wherein the voltage drop pump is configured to reduce the input voltage by at least one of a plurality of preset pressure-reduction ratios according to an input control signal.

5. The DC/DC converter of claim 1, wherein the voltage drop pump is configured to bypass and output the input voltage according to an input control signal.

6. The DC/DC converter of claim 1, wherein the voltage drop pump includes:
a plurality of capacitors connected in series; and
a plurality of switching elements configured to control a connection between the plurality of capacitors, and
wherein the plurality of switching elements is switched so that the input voltage is reduced by a predetermined ratio according to an input control signal.

7. The DC/DC converter of claim 1, wherein the voltage drop pump is connected in parallel with the boost converter.

8. The DC/DC converter of claim 1, further comprising a control circuit configured to control at least one of the boost converter, the voltage drop pump, and the charge pump.

9. The DC/DC converter of claim 8, wherein the control circuit is configured to adjust a reduction ratio of the voltage drop pump by transmitting a first control signal to the voltage drop pump, and
wherein the voltage drop pump is configured to supply the second voltage, which is reduced based on the adjusted reduction ratio, as driving power for an integrated circuit.

10. The DC/DC converter of claim 8, wherein the control circuit is configured to determine a first voltage boosted by the boost converter by transmitting a second control signal to the boost converter.

11. The DC/DC converter of claim 10, wherein a magnitude of the first voltage boosted by the boost converter is determined by a duty of a switching element included in the boost converter.

12. The DC/DC converter of claim 8, wherein the control circuit is configured to control the charge pump to generate the third voltage by transmitting a third control signal to the charge pump.

13. The DC/DC converter of claim 8, wherein the control circuit is configured to bypass and output the voltage input to the charge pump based on checking that a size of the input voltage is greater than or equal to a set value.

14. The DC/DC converter of claim 1, wherein the output voltage of the charge pump is supplied to an LED string connected to the charge pump.

15. A DC/DC converter comprising:
a selection circuit configured to select and output a first power signal or a second power signal;
a boost converter configured to boost the first power signal or the second power signal output from the selection circuit to a set first voltage; and
a charge pump configured to generate a second voltage as the output voltage by boosting the first voltage output from the boost converter,
wherein the charge pump is configured to bypass and output the first voltage output from the boost converter when the selection circuit selects the second power signal in response to an input control signal.

16. The DC/DC converter of claim 15, wherein the charge pump is configured to output the first voltage output from the boost converter by boosting an integer multiple in response to the selection circuit selecting the second power signal.

17. The DC/DC converter of claim 15, wherein a voltage of the second power signal is greater than a voltage of the first power signal.

18. The DC/DC converter of claim 15, further comprising a control circuit configured to determine the first voltage boosted by the boost converter by transmitting a control signal to the boost converter.

19. A DC/DC converter, comprising:
a boost converter configured to boost an input voltage to a set first voltage;
a voltage drop pump configured to reduce the input voltage to a set second voltage;
a charge pump configured to generate a third voltage boosted from the input voltage as an output voltage based on the first voltage and the second voltage; and
a controller driven based on the second voltage generated by the voltage drop pump.

20. The DC/DC converter of claim 19, wherein the voltage drop pump is configured to reduce the input voltage to at least one of a plurality of preset pressure reduction ratios according to an input control signal.
